(19) United States
(12) Patent Application Publication
(10) Pub. No.: US 2006/0015471 A1
(43) Pub. Date: Jan. 19, 2006

(54) System, Method, and Computer Program Product of Building A Native XML Object Database

(75) Inventor: Lisa Wu, Cliffside Park, NJ (US)

Correspondence Address: GMORPHER INC., P.O Box 9, FORT LEE, NJ, 07024, US

(73) Assignee: GMORPHER INCORPORATED, Port Jefferson Station, NY (US)

(21) Appl. No.: 10/710,299

(22) Filed: Jul. 1, 2004

(51) Int. Cl. G06F 17/30

(52) U.S. Cl. 707/1

(57) ABSTRACT

A method, system, and computer program product of building a Native XML Object Database, the present invention dynamically generates database API from object-oriented design and persists data in native XML files. The structure of data is maintained from front end API to back end file storage for better security and performance.

### BACKGROUND OF INVENTION

1. Field of the Invention

The present invention is about building an NXOD—Native XML Object Database that is object oriented in the API layer and native XML in the persistence layer.

2. Related Art

A typical database system comprises of three layers: API, database core, and data persistence. The API layer takes orders from external database applications. The database core processes orders, causes physical changes in the persistence layer, reports the processing result to the API layer, which in turn reports to external applications.

Modern database technology renders mainly three categories of databases: relational database, object database, and XML database. Relational databases focus on relationships between tables and integrity of data while object and XML databases emphasis on mapping real world entity relationships to the structure of data. XML databases use XML in either or both of the API and persistence layers.

Database applications interact with databases mainly through three categories of APIs: SQL, Get/Set operations, and SOAP. SQL is a query language for relational databases; Get/Set operations are programming interfaces for object databases, get operation being for data retrieval, set for data update/removal; SOAP is an XML plain text messaging mechanism for XML databases.

A data file at the persistence layer can take a proprietary binary form or a plain text form. Most of the relational and object databases use a binary form. XML databases use an XML plain text form or a binary form.

XML databases comprise of XML enabled database and Native XML database. A relational or object database is an XML enabled database if it supports SOAP API or XML data input/output. A native XML database uses XML for data file format at the persistence layer, or saves data to proprietary data stores via DOM—Document Object Model. SQL Server 2000 by Microsoft, for instance, is an XML enabled relational database management system; Matisse by Matisse Software an XML enabled object database management system; dbXML by dbXML Group a native XML database management system.

The present invention uses Get/Set operations at the API layer and XML files for data persistence. That is how NXOD—Native XML Object Database gets named.

Database systems on the market support a variety of programming interfaces: C, C++, Java, Perl, etc. All of the APIs are static, manually coded, and shipped along with their respective products. The present invention provides means and steps of dynamically generating APIs based on object oriented design. Dynamic NXOD API is more user friendly, which cuts database application development time. Dynamic NXOD API also embeds data links to achieve fast query processing and database transactions.

In the persistence layer, U.S. patent application No. 20040103105 by Christopher Lindablad and Paul Padersen proposes a tree like hierarchy for the data store. As it assumes static APIs, data links are embedded in the tree. Also, It does not examine data persistence in a coherent lifecycle of design, API, and storage. In XNOD, API and storage hierarchy are driven by object oriented design.

Existing native XML databases are trying to store the structure of data in XML files, which has performance penalties due to XML parsing of nested structures. The present invention separates structure and value of data. The hierarchy is represented by file system paths. Native XML files have flat structures and store name/value pairs. No elements except the document root in the XML file has child elements. When viewing the data store as a tree, all the inner nodes including the root are file directories; all leaf nodes are XML files.

At the database design phase, all three categories of databases start from entity relationship diagrams. Relational databases then map the entity relationship diagrams to tables that satisfy Boyce-Codd Normal Form; object and XML databases to a hierarchy of objects.

The present invention starts from entity relationship diagrams. The data representation, however, is both a set of relational tables and a hierarchy of objects.

### SUMMARY OF INVENTION

The present invention provides steps and means for building an NXOD—Native XML Object Database that offers a combination of features from heterogeneous database systems. NXOD follows an object-oriented design. The data representation is both of normalized tables like in relational databases, and of a tree of objects like in object databases. At the front end, NXOD offers a set of getters and setters like in object databases. At the back-end, NXOD saves data in XML files like in native XML databases.

The present invention comprises of following differentiators: 1) Dynamic design driven API, 2) Separation of structure and value of data, 3) Data links embedded in dynamic API, 4) Better granularity for data access control and encryption, 4) Better reliability and resilience to data corruptions, 5) Smaller memory footprint, faster query processing and operations.

In a word, being a hybrid of native XML and object databases, the present invention innovates in API, implementation, storage, security, and performance.

### BRIEF DESCRIPTION OF DRAWINGS

FIG. 1 depicts an embodiment of the present invention NXOD to interact with an external database application via Get/Set operation pairs.

FIG. 2 depicts a generic workflow of the present invention.

FIG. 3 depicts a sample object oriented design utilized by NXOD.

FIG. 4 depicts a sample mapping from said design to a file system structure.

FIG. 5 depicts the database core and its internal working.

### DETAILED DESCRIPTION

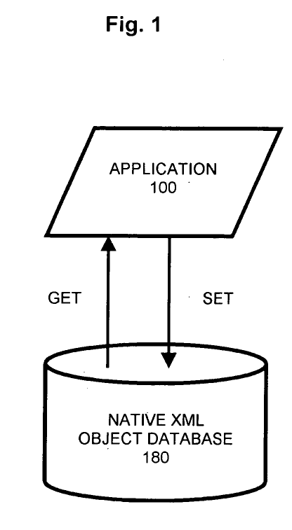

The present invention hides all the complexity of database queries from end users. As depicted in FIG. 1, NXOD 180 interacts with external applications 100 via Get/Set operations.

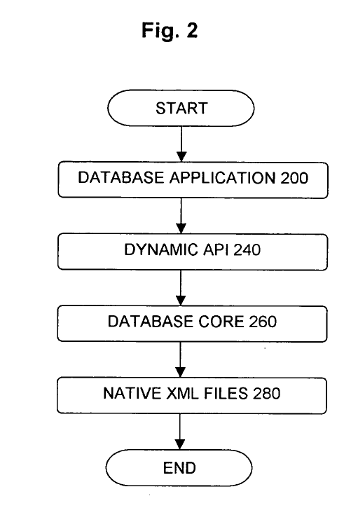

FIG. 2 offers a close view of how the present invention works in real world. First, the Database Application 200 talks to dynamic API 240, which talks to the Database Core 260, which manipulates native XML files 280.

Data Mapping

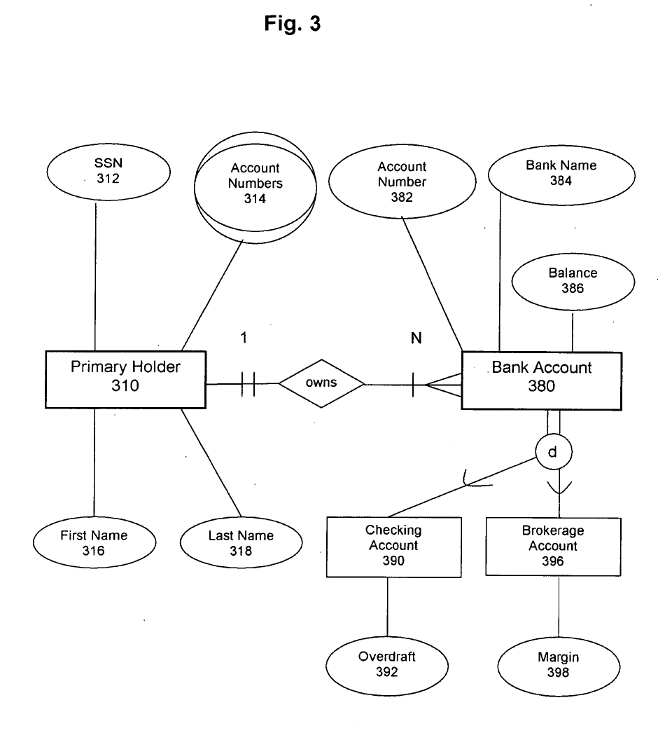

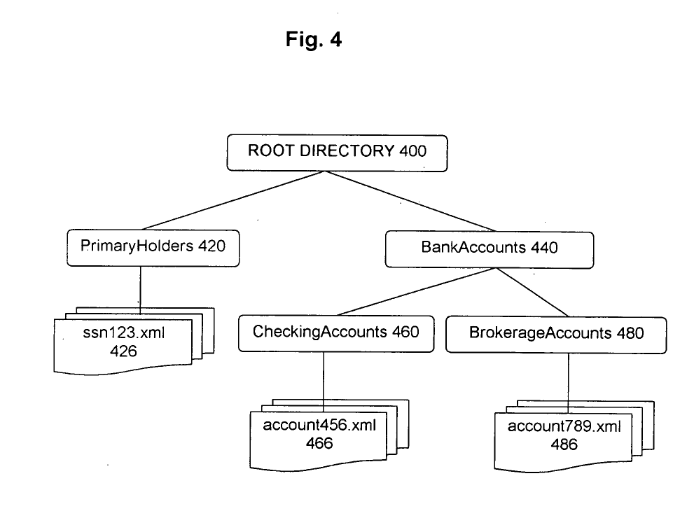

The present invention provides steps and means for transparently mapping an object oriented database design, an entity relationship diagram as depicted in FIG. 3, to the file system structure as depicted in FIG. 4. For simplicity, said database design comprises two entities: Primary Holder 310 and Bank Account 380. The relationship is 1 to N, i.e., one primary account holder can have one or more bank accounts, but one bank account can only have one primary holder. Primary Holder has four attributes: SSN 312, Account Numbers 314, First Name 316, and Last Name 318. Account Numbers holds a list of bank account numbers that reference to Bank Account 380.

Bank Account has three attributes: Account Number 382, Bank Name 384, and Balance 386. Bank Account has two descendant entities: Checking Account 390 and Brokerage Account 396. Checking account has an attribute Overdraft 392; Brokerage Account an attribute Margin 398.

The present invention follows said design and dynamically generates following interfaces and classes, which can be done in any object-oriented programming language. See the Program Listing Deposit for Java examples.

1. Interfaces: i) IPrimaryHolder extends Identity, ii) IBankAccount extends Identity, iii) ICheckingAccount extends IBankAccount, iv) IBrokerageAccount extends IBankAccount.

2. Implementation Classes: i) PrimaryHolder implements IPrimaryHolder, ii) BankAccount implements IBankAccount, iii) CheckingAccount extends BankAccount implements IBankAccount, iv) BrokerageAccount extends BankAccount implements IBrokerageAccount.

3. Query Classes: i) PrimaryHolders runs queries for PrimaryHolder, ii) BankAccounts runs queries for BankAccount, iii) CheckingAccounts runs queries for CheckingAccount, iv) BrokerageAccounts runs queries for BrokerageAccount.

Running sample database Application A in the Program Listing Deposit stores Primary Holder data in the XML content:

<?xml version=“1.0”encoding=“utf-8” ?>
<PrimaryHolder> <ssn>123</ssn>
<userName>a_user</userName>
<firstName>John</firstName>
<lastName>Smith</lastName>
<accountNumber>456</accountNumber>
<accountNumber>789</accountNumber>
</PrimaryHolder>

Running sample database Application B in the Program Listing Deposit stores Checking Account data in the XML content:

<?xml version=“1.0”encoding=“utf-8” ?>
<CheckingAccount> <userName>a_user</userName>
<accountNumber>456</accountNumber>
<bankName>a_bank</bankName>
<balance>2000.68</balance>
<overdraft>1000.00</overdraft> </CheckingAccount>

Running sample database Application C in the Program Listing Deposit stores Brokerage Account data in an XML content:

<?xml version=“1.0”encoding=“utf-8”?>
<BrokerageAccount> <userName>a_user</userName>
<accountNumber>456</accountNumber>
<bankName>b_bank</bankName>
<balance>8000.26</balance> <margin>yes</margin>
</BrokerageAccount>

Said XML contents are saved in the file system as depicted in FIG. 4. The ROOT DIRECTORY 400 is created while NXOD is being loaded. Execution of said sample database applications causes four directories and three files to be created. Directory PrimaryHolders 420 contains XML file 426. Directory BankAccount 440 has two sub directories (to map said inheritance of bank account entities): CheckingAccounts 60 and BrokerageAccounts 480. CheckingAccounts contains XML file 466; BrokerageAccounts XML file 486.

Each XML file stores one instance of the data object. Data for 1000 primary account holders will be stored in 1000 XML files under the PrimaryHolders directory 420. Each primary account holder can have one or more checking accounts. The number of XML files under the CheckingAccounts directory 460 is the total number of checking accounts held by all primary account holders. The number of XML files under the BrokerageAccounts directory 486 is the total number of brokerage accounts held by all primary account holders.

The present invention separates structure from value of data. As depicted in FIG. 4, the hierarchy is represented by file paths. Flat name/value pairs are stored in XML files 426, 466, and 486.

Database Query

The present invention eliminates the need for a query language like SQL or XQuery. An NXOD query is initiated by the external application 200 and executed by a series of get operations in the API 240 and the database core 260.

Locating an instance of data is by following said data link (file path) embedded in said dynamic API. As shown in the Program Listing Deposit, at each data object instantiation, a database handler called entrance is constructed. For example,

entrance=Manager.getEntrance(PrimaryHolders.dataDir, ssn);

This is to say, the parent directory of a PrimaryHolder data file is PrimaryHolders. The returned object entrance points to the instance of specific ssn.

Print out all ssn, bank account numbers, and balances. Application D in the Program Listing Deposit executes this query.

Security

The present invention delivers access control to each instance of the data. Each XML file has a username element to hold the user credential against which data access can be checked in real time. As shown in said sample applications, user name is a required argument for object instantiation.

The present invention delivers data encryption to the attribute/field level. For example, ssn—social security number of the primary holder is sensitive data and needs to be encrypted. As ssn is an argument for the PrimaryHolder constructor, an encryption utility is called from the constructor as listed in APIE in the Program Listing Deposit.

After setting values for userName, firstName, lastName, and accountNumber, the XML data content 466 looks as follows. You can see ssn gets encrypted.

<?xml version=“1.0”encoding=“utf-8”?>
<PrimaryHolder> <ssn>*(\hat{ }Re#%[KrP$</ssn>
<userName>a_user</userName>
<firstName>John</firstName>
<IastName>Smith</IastName>
<accountNumber>456</accountNumber>
<accountNumber>789</accountNumber>
</PrimaryHolder>

Comparisons

Given said bank account example, the present invention differentiates itself throughout the design process, API and persistence layers.

Relational databases starts with entity relationship diagrams, but most likely with no entity inheritance like bank accounts 380, 390, and 396. Also, relational database systems do not support native arrays or lists.

From a relational perspective, NXOD creates three tables: PrimaryHolder—ssn, firstName, lastName, accountNumbers; CheckingAccount—accountNumber, bankName, balance, overdraft; BrokerageAccount—accountNumber, bankName, balance, margin.

A relational database, however, takes a more fragmented approach. Four tables are created: PrimaryHolder—ssn, firstName, lastName; BankAccount—accountNumber, bankName, balance, ssn; CheckingAccount—accountNumber, overdraft; BrokerageAccount—accountNumber, margin.

Now, PrimaryHolder and account tables are linked by ssn instead of accountNumber in NXOD. The obvious fact that the primary holder has several bank accounts becomes hidden among the relationships. Given social security number ‘23456789’print out his/her bank account numbers. A relational database application will run a SQL statement with externally configured access control:

SELECT ACCOUNTNUMBER FROM BANKACCOUNTS WHERE SSN=123456789

The present invention executes in said sample Java application following statements with a built-in security:

PrimaryHolder holder=new PrimaryHolder(credential, ssn);

String [ ]accounts=holder.listAccounts();

An object database would run following statements with pre-manufactured API and an externally configured security:

IClass iClass = findData−
Class(path_to_PrimaryHolder_class);
IObject object = iClass.constructObject(ssn);
String []accounts = (String
[])object.getPropertyValue(accountNumbers);

An XML database application would send a bulky SOAP message with externally configured security:

<?xml version=“1.0”encoding=“UTF-8”?>
<soapenv:Envelope
xmlns:soapenv=“ttp://schemas.xmlsoap.org/soap/envelope/
“xmlns:xsd=“ttp://www.w3.org/2001/XMLSchema“xmlns:
xsi=“ttp://www.w3.org/2001/XMLSchema-instance” <
soapenv:Body> <listAccounts
xmlns=“rn:PrimaryHolder.gmorpher.com”
</listAccounts> </soapenv:Body>

In the persistence layer, relational, object, and some XML oriented databases store data in one blob file, which makes database vulnerable for data corruptions. Existing native XML databases may store data in a tree of XML files, but each XML has nested structures of data. The database is still vulnerable for local data corruptions.

The present invention maps the structure of data to file system paths. Each XML data file is flat and holds name/value pairs, but no nested structures. Each XML data file represents one instance of data, which is a row/tuple from a relational perspective. Therefore, data corruption is quarantined and minimized to the row/tuple level.

On the performance side, as structure of data is mapped to file system paths, locating a piece of data triggers OS system calls, which are faster than application level method invocations. NXOD has the ability to load any desired row of data on the fly without engaging unrelated data while existing databases need to load the whole blob file or deeply nested XML files into memory even if only a small portion of data is actually accessed. Therefore, NXOD has smaller memory footprints and faster transactions.

DataBase Core

The present invention provides means and steps for building a processing center to map Get/Set operations in the API layer to XML content changes in the persistence layer. Get operations in the API comprising of getxxx() and listxxx( ) where xxx is the data field name, are for data retrieval. Set operations in the API comprising of setxxx( ), deletexxx( ), addxxx( ), removexxx( ), and commit( ), are for data modifications. addxxx( ) and removexxx( ) are for a list of values/references.

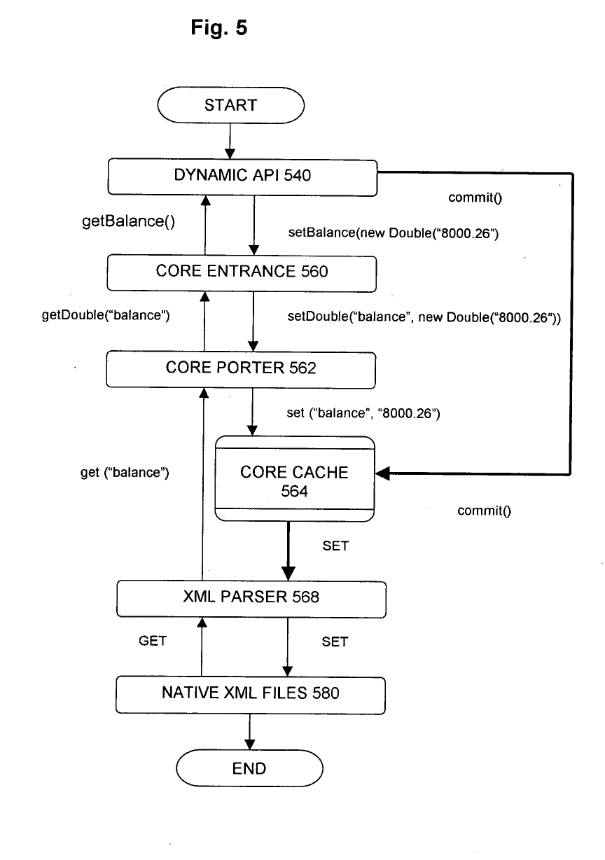

FIG. 5 can be viewed as an expansion of FIG. 2 to drill down to the database core which comprises of four major components: 560, 562, 564, and 568.

Dynamic API 540 starts a representative get operation getBalance( ). Core Entrance 560 translates it into getDouble(“balance”); then Core Porter 562 into get(“balance”) The computer-readable program code of the present invention utilizes Apache Xerces XML parser for component 568, which translates the get operation further into getNodeValue( ) and fetches data from XML Files 580.

API 540 also starts a representative set operation setBalance( ). Core Entrance 560 translates it into setDoubleo. Core Porter 562 sets the value to Core Cache 564. To persist cumulative set operations, the external application calls commito exposed via API 540, which saves the changes to XML Files 580 and cleans up Core Cache 564.

Create, update, delete are three major NXOD operations at the data field level. The set operation in dynamic API 540 causes a new field value to be created if it is not preexistent. Otherwise, it is an update operation to overwrite existent data. Therefore, create and update map to setxxx( ) in dynamic API 540 for a single value/reference, to addxxx( ) for a list of values/references. And delete maps to deletexxx( ) or removexxx( ). See the Program Listing Deposit for Java code examples.

At the instance/tuple level, NXOD starts with the instantiation of a data object. If the instance does not exist, it is an insertion operation; update operation, otherwise. Delete is accomplished by removing the correspondent XML file.

What is claimed is:

1. A method of building a native XML object database, comprising the step of representing structured data in native XML files.

2. The method according to claim 1, further comprising steps of: creating one or more directories in the file system; creating one or more XML files under said directories.

3. The method according to claim 2, wherein the directory creating step further comprises the step of mapping said structure of data to file system paths.

4. The method according to claim 2, wherein the XML file creating step further comprises the step of creating one XML file for each instance of said data.

5. The method according to claim 4, wherein the created XML file has a flat structure.

6. The method according to claim 1, further comprising the step of mapping object-oriented design to dynamically generated API.

7. The method according to claim 6, wherein the dynamic API is generated in Java.

8. The method according to claim 6, wherein the dynamic API embeds links for said structure of data.

9. A system for building a native XML object database, comprising means for representing structured data in native XML files.

10. The system according to claim 9, further comprising means for encrypting selected data fields in said native XML files.

11. The system according to claim 9, further comprising means for delivering data access control to each instance of data.

12. The system according to claim 9, further comprising means for minimizing damages of data corruption to instances of data.

13. The system according to claim 9, further comprising means for minimizing database memory usage.

14. The system according to claim 9, further comprising means for speeding up database operations.

15. A computer program product for building a native XML object database, the computer program product embodied on one or more computer-readable media and comprising computer-readable program code means for representing structured data in native XML files.

16. The computer program product according to claim 15, further comprising computer-readable program code means for mapping object-oriented design to dynamically generated Java API.

17. The computer program product according to claim 16, further comprising computer-readable program code means for: generating constructors for building database handlers given file paths in said file system; generating getters and setters for data fields.

18. The computer program product according to claim 15, further comprising computer-readable program code means for: creating/updating/deleting identity of said data in said XML files; creating/updating/deleting values or list of values of said data in said XML files; creating/updating/deleting references or list of references to other values under said structure.
